(19) United States
(12) Patent Application Publication
(10) Pub. No.: US 2015/0035800 A1
(43) Pub. Date: Feb. 5, 2015

(54) INFORMATION TERMINAL APPARATUS

(71) Applicant: Kabushiki Kaisha Toshiba, Tokyo (JP)

(72) Inventors: Mineharu Uchiyama, Kanagawa (JP); Yasuhiro Shiino, Tokyo (JP); Mayuko Yoshida, Tokyo (JP); Junya Suzuki, Kanagawa (JP); Keiichiro Mori, Kanagawa (JP); Hiroyuki Oka, Tokyo (JP); Hideki Yagi, Tokyo (JP); Yoshihiro Kato, Tokyo (JP); Ai Matsui, Kanagawa (JP)

(73) Assignee: KABUSHIKI KAISHA TOSHIBA, Tokyo (JP)

(21) Appl. No.: 14/199,841

(22) Filed: Mar. 6, 2014

(30) Foreign Application Priority Data
Aug. 1, 2013 (JP) 2013-160537

(51) Int. Cl. G06F 3/042; G06F 3/041

(52) U.S. Cl. CPC G06F 3/0421; G06F 3/0416
USPC 345/175; 345/173

(57) ABSTRACT

According to an embodiment, an information terminal apparatus includes: a display device equipped with a touch panel; a position detecting section configured to detect a position of a material body in a three-dimensional space opposite to a display surface of the display device; and a command generating section configured to generate a predetermined command for causing predetermined processing to be executed, on the basis of touch position information of a touch position on the touch panel by a touch operation on the touch panel and position-in-space information of the material body in the three-dimensional space detected by the position detecting section after the touch panel is touched or in a state of the touch panel being touched.

### CROSS-REFERENCE TO RELATED APPLICATION

This application is based upon and claims the benefit of priority from the Japanese Patent Application No. 2013-160537, filed on Aug. 1, 2013; the entire contents of which are incorporated herein by reference.

### FIELD

An embodiment described herein relates generally to an information terminal apparatus.

### BACKGROUND

Recently, information terminal apparatuses such as a smartphone, a tablet terminal and a digital signage have become widespread. These information terminal apparatuses have a display device equipped with a touch panel.

The touch panel is widely used for smartphones, tablet terminals and the like because the touch panel makes it possible for a user to simply perform specification of a command, selection of an object or the like by touching a button, an image or the like displayed on a screen.

Recently, a technique making it possible to specify a command by a gesture in a game machine has been put to practical use. Since a gesture is a three-dimensional motion, it is possible to specify a command by a more intuitive motion in comparison with the touch panel.

In the case of specifying a command only by a gesture, there is a problem that precision of recognizing a gesture motion is low. Therefore, complicated processing is required for high-precision gesture recognition processing.

Though the touch panel makes it possible to perform a simple operation, it is possible to specify only a command for selecting an object or the like, and it is not possible to perform an intuitive operation like a gesture (as if an analog book).

### BRIEF DESCRIPTION OF THE DRAWINGS

FIG. 1 is an overview diagram of a tablet terminal which is an information terminal apparatus according to a first embodiment;

FIG. 2 is a block diagram showing a configuration of a tablet terminal 1 according to the first embodiment;

FIG. 3 is a diagram for illustrating a motion judgment space FDA according to the first embodiment;

FIG. 4 is a diagram for illustrating light emission timings of respective light emitting sections 6 and light receiving timings of a light receiving section 7 according to the first embodiment;

FIG. 5 is a diagram for illustrating optical paths through which lights emitted from the light emitting sections 6 are received by the light receiving section 7 seen from above the display area 3a of the tablet terminal 1 according to the first embodiment;

FIG. 6 is a graph showing a relationship between a position of a finger F in an X direction and a rate Rx according to the first embodiment;

FIG. 7 is a diagram for illustrating optical paths through which lights emitted from the light emitting sections 6 are received by the light receiving section 7 seen from above the display area 3a of the tablet terminal 1 according to the first embodiment;

FIG. 8 is a graph showing a relationship between a position of a finger F in a Y direction and a rate Ry according to the first embodiment;

FIG. 9 is a diagram for illustrating the optical paths through which lights emitted from the light emitting sections 6 are received by the light receiving section 7 seen from a left side of the tablet terminal 1 according to the first embodiment;

FIG. 10 is a diagram for illustrating the optical paths through which lights emitted from the light emitting sections 6 are received by the light receiving section 7 seen from an upper side of the tablet terminal 1 according to the first embodiment;

FIG. 11 is a graph showing a relationship between a position of a finger F in a Z direction and a sum SL of three amounts of light received according to the first embodiment;

FIG. 12 is a diagram showing an example of displaying an electronic book according to the first embodiment;

FIG. 13 is a diagram showing a state in which a user performs a motion of detaching a thumb F1 and a forefinger F2 from the display area 3a and moving the two fingers F1 and F2 toward an upper left direction, that is, a gesture of turning a page;

FIG. 14 is a flowchart showing an example of a flow of a command judging process by a touch panel function and a three-dimensional space position detecting function, according to the first embodiment;

FIG. 15 is a perspective view of the tablet terminal 1 with one scene of an electronic picture book displayed on the display device 3, according to the first embodiment;

FIG. 16 is a perspective view of the tablet terminal 1 with one scene of the electronic picture book displayed on the display device 3, according to the first embodiment;

FIG. 17 is a diagram for illustrating a method for specifying a command for performing enlarged display of an object displayed in the display area 3a, according to a second embodiment;

FIG. 18 is a diagram for illustrating a method for specifying the command for performing enlarged display of the object displayed in the display area 3a, according to the second embodiment;

FIG. 19 is a diagram for illustrating a method for specifying a command for performing reduced display of an object displayed in the display area 3a, according to the second embodiment;

FIG. 20 is a diagram for illustrating a method for specifying the command for performing reduced display of the object displayed in the display area 3a, according to the second embodiment;

FIG. 21 is a diagram showing an amount of zoom in enlargement and reduction according to the second embodiment;

FIG. 22 is a flowchart showing an example of a flow of a command judging process for performing enlarged and reduced display of an object by a touch panel function and a three-dimensional space position detecting function according to the second embodiment;

FIG. 23 is a diagram for illustrating a method for specifying a command for scrolling according to a third embodiment;

FIG. 24 is a diagram for illustrating a method for specifying a command for changing shade of color according to the third embodiment;

FIG. 25 is a diagram for illustrating a method for specifying rotation of a figure according to the third embodiment;

FIG. 26 is a diagram for illustrating a method for specifying scrolling of a screen excluding an image at a specified position, according to a third embodiment;

FIG. 27 is a flowchart showing an example of a flow of a command judging process by a touch panel function and a three-dimensional space position detecting function according to the third embodiment, according to the third embodiment; and

FIG. 28 is a block diagram showing a configuration of a control section including a command generating section, according to each of the first to third embodiments.

### DETAILED DESCRIPTION

An information terminal apparatus of an embodiment includes: a display device equipped with a touch panel; a position detecting section configured to detect a position of a material body in a three-dimensional space opposite to a display surface of the display device; and a command generating section configured to generate a predetermined command for causing predetermined processing to be executed, on the basis of touch position information of a touch position on the touch panel by a touch operation on the touch panel and position-in-space information of the material body in the three-dimensional space detected by the position detecting section after the touch panel is touched or in a state of the touch panel being touched.

The embodiment will be described below with reference to drawings.

### First Embodiment

### Configuration

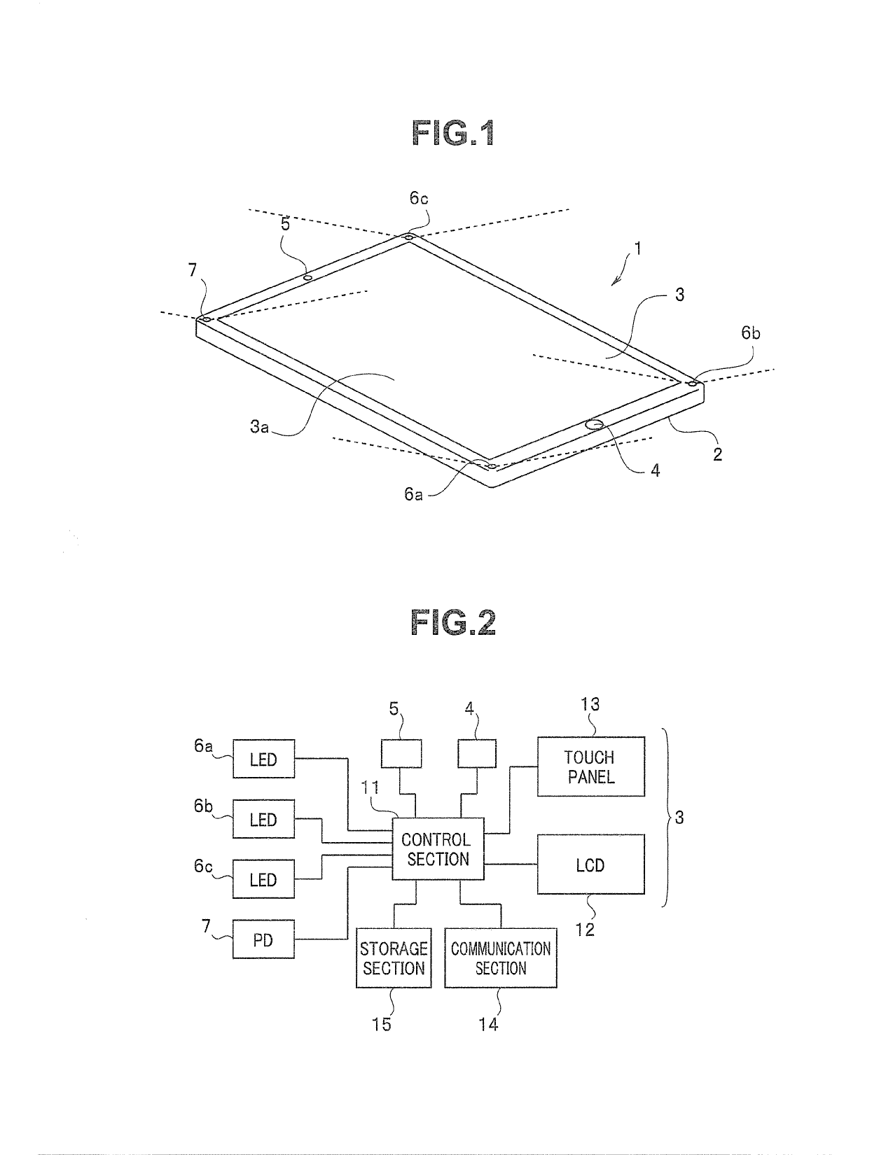

FIG. 1 is an overview diagram of a tablet terminal which is an information terminal apparatus according to an embodiment.

Note that, though a tablet terminal is described as an example of the information terminal apparatus, the information terminal apparatus may be a smartphone, digital signage or the like which is equipped with a touch panel.

A tablet terminal 1 has a thin plate shaped body section 2 and a rectangular display area 3a of a display device 3 equipped with a touch panel is arranged on an upper surface of the body section 2 so that an image is displayed on the rectangular display area 3a. A switch 4 and a camera 5 are also arranged on an upper surface of the tablet terminal 1. A user can connect the tablet terminal 1 to the Internet to browse various kinds of sites or execute various kinds of pieces of application software. On the display area 3a, various kinds of site screens or various kinds of screens generated by the various kinds of pieces of applications are displayed.

The switch 4 is an operation section operated by the user to specify on/off of the tablet terminal 1, jump to a predetermined screen, and the like.

The camera 5 is an image pickup apparatus which includes an image pickup device, such as a CCD, for picking up an image in a direction opposite to a display surface of the display area 3a.

Three light emitting sections 6a, 6b and 6c and one light receiving section 7 are arranged around the display area 3a of the tablet terminal 1.

More specifically, the three light emitting sections 6a, 6b and 6c (hereinafter also referred to as the light emitting sections 6 in the case of referring to the three light emitting sections collectively or the light emitting section 6 in the case of referring to any one of the light emitting sections) are provided near three corner parts among four corners of the rectangular display area 3a, respectively, so as to radiate lights with a predetermined wavelength within a predetermined range in a direction intersecting the display surface of the display area 3a at a right angle as shown by dotted lines.

The light receiving section 7 is provided near one corner part among the four corners of the display area 3a where the three light emitting sections 6 are not provided so as to receive lights within a predetermined range as shown by dotted lines. That is, the three light emitting sections 6a, 6b and 6c are arranged around the display surface of the display device 3, and the light receiving section is also arranged around the display surface.

Each light emitting section 6 has a light emitting diode (hereinafter referred to as an LED) configured to emit a light with a predetermined wavelength, a near-infrared light here, and an optical system such as a lens. The light receiving section 7 has a photodiode (PD) configured to receive a light with a predetermined wavelength emitted by each light emitting section 3, and an optical system such as a lens. Since the near-infrared light whose wavelength is longer than that of a visible red light is used here, the user cannot see the light emitting section 6 emitting the light. That is, each light emitting section 6 emits a near-infrared light as a light with a wavelength outside a wavelength range of visible light.

An emission direction of lights emitted from the light emitting sections 6 is within a predetermined range in the direction intersecting the surface of the display area 3a at a right angle, and a direction of the light receiving section 7 is set so that the light emitted from each light emitting section 6 is not directly inputted into the light receiving section 7.

That is, each light emitting section 6 is arranged so as to have such an emission range that a light is emitted to a space which includes a motion judgment space FDA on an upper side of the display area 3a, which is to be described later, by adjusting a direction or the like of the lens of the optical system provided on an emission side. Similarly, the light receiving section 7 is also arranged so as to have such an incidence range that a light enters from the space which includes the motion judgment space FDA on the upper side of the display area 3a, which is to be described later, by adjusting a direction or the like of the lens of the optical system provided on an incidence side.

FIG. 2 is a block diagram showing a configuration of the tablet terminal 1. As shown in FIG. 2, the tablet terminal 1 is configured, being provided with a control section 11, a liquid crystal display device (hereinafter referred to as an LCD) 12, a touch panel 13, a communication section 14 for wireless communication, a storage section 15, the switch 4, the camera 5, the three light emitting sections 6 and the light receiving section 7. The LCD 12, the touch panel 13, the communication section 14, the storage section 15, the switch 4, the camera 5, the three light emitting sections 6 and the light receiving section 7 are connected to the control section 11.

The control section 11 includes a central processing unit (hereinafter referred to as a CPU), a ROM, a RAM, a bus, a rewritable nonvolatile memory (for example, a flash memory) and various kinds of interface sections. Various kinds of programs are stored in the ROM and the storage section 15, and a program specified by the user is read out and executed by the CPU.

The LCD 12 and the touch panel 13 constitute the display device 3. That is, the display device 3 is a display device equipped with a touch panel. The control section 11 receives a touch position signal from the touch panel 13 and executes predetermined processing based on the inputted touch position signal. The control section 11 provides a graphical user interface (GUI) on a screen of the display area 3a by generating and outputting screen data to the LCD 12 which has been connected.

The communication section 14 is a circuit for performing wireless communication with a network such as the Internet and a LAN, and performs the communication with the network under control of the control section 11.

The storage section 15 is a mass storage device such as a hard disk drive device (HDD) and a solid-state drive device (SSD). Not only the various kinds of programs but also various kinds of data are stored.

The switch 4 is operated by the user, and a signal of the operation is outputted to the control section 11.

The camera 5 operates under the control of the control section 11 and outputs an image pickup signal to the control section 11.

As described later, each light emitting section 6 is driven by the control section 11 in predetermined order to emit a predetermined light (here, a near-infrared light).

The light receiving section 7 receives the predetermined light (here, the near-infrared light emitted by each light emitting section 6) and outputs a detection signal according to an amount of light received, to the control section 11.

The control section 11 controls light emission timings of the three light emitting sections 6 and light receiving timings of the light receiving section 7, and executes predetermined operation and judgment processing to be described later, using a detection signal of the light receiving section 7. When predetermined conditions are satisfied, the control section 11 transmits predetermined data via the communication section 14.

In the present embodiment, a space for detecting a motion of a finger within a three-dimensional space on the display area 3a is set, and a motion of the user's finger within the space is detected. (Position detection of finger within three-dimensional space on display area)

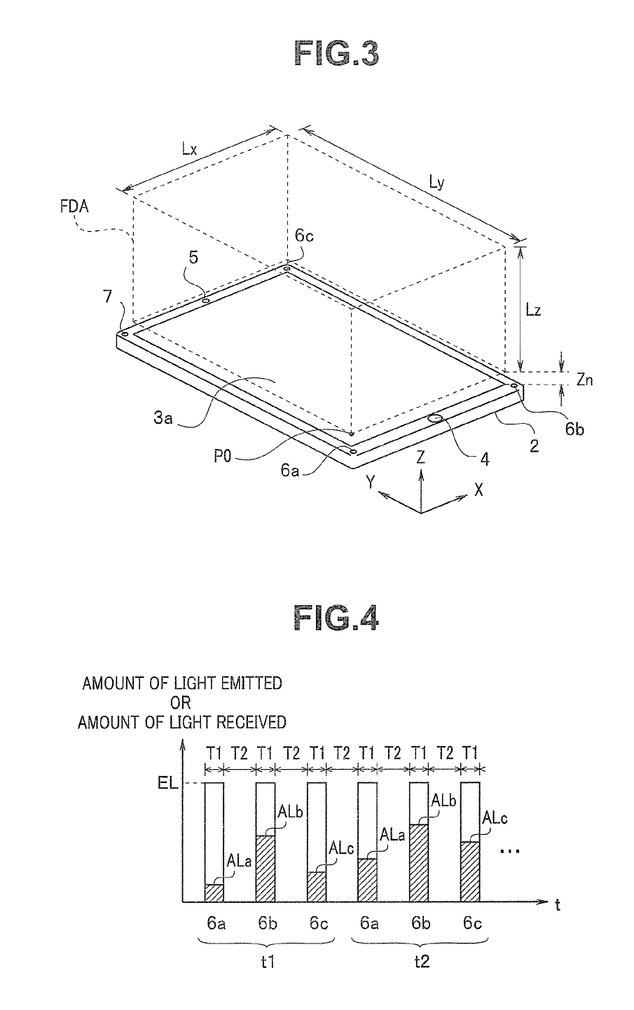

FIG. 3 is a diagram for illustrating the motion judgment space FDA which is an area for detecting a motion of a finger above and separated from the display area 3a.

As shown in FIG. 3, the motion judgment space FDA of the present embodiment is a cuboid space set above and separated from the display area 3a. Here, when it is assumed that, in the motion judgment space FDA, a direction of a line connecting the light emitting sections 6a and 6b is an X direction, a direction of a line connecting the light emitting sections 6b and 6c is a Y direction, and a direction intersecting the surface of the display area 3a is a Z direction, the motion judgment space FDA is a cuboid space extending toward the Z direction from a position separated from the display area 3a in the Z direction by a predetermined distance Zn, along a rectangular frame of the display area 3a. Therefore, the motion judgment space FDA is a cuboid having a length of Lx in the X direction, a length of Ly in the Y direction and a length of Lz in the Z direction. For example, Lz is a length within a range of 10 to 20 cm.

The motion judgment space FDA is specified at a position separated from the surface of the display area 3a by the predetermined distance Zn. This is because there is a height range in the Z direction where the light receiving section 7 cannot receive a reflected light from a finger F. Therefore, the motion judgment space FDA is set within a range except the range where light receiving is impossible. Here, as shown in FIG. 3, a position at a left end of the X direction, a bottom end of the Y direction and a bottom end of the Z direction is assumed to be a reference point P0 of the position of the motion judgment space FDA.

FIG. 4 is a diagram for illustrating light emission timings of the light emitting sections 6 and light receiving timings of the light receiving section 7. In FIG. 4, a vertical axis indicates an amount of light emitted or an amount of light received, and a horizontal axis indicates a time axis.

The control section 11 causes the three light emitting sections 6a, 6b and 6c in predetermined order with a predetermined amount of light EL. As shown in FIG. 4, the control section 11 causes the light emitting section 6a among the three light emitting sections 6 to emit a light during a predetermined time period T1 first and, after elapse of a predetermined time period T2 after light emission by the light emitting section 6a, causes the light emitting section 6b to emit a light during the predetermined time period T1. Then, after elapse of the predetermined time period T2 after light emission by the light emitting section 6b, the control section 11 causes the light emitting section 6c to emit a light for the predetermined time period T1. Then, after elapse of the predetermined time period T2 after light emission by the light emitting section 6c, the control section 11 causes the light emitting section 6a to emit a light for the predetermined time period T1 and subsequently causes the second light emitting section 6b to emit a light. In this way, the control section 11 repeats causing the first to third light emitting sections 6a, 6b and 6c to emit a light in turn.

That is, the three light emitting sections 6a, 6b and 6c emit lights at mutually different timings, respectively, and the light receiving section 7 detects reflected lights of the lights emitted by the three light emitting sections 6a, 6b and 6c, respectively, according to the different timings.

The control section 11 causes the three light emitting sections 6 at predetermined light emission timings as described above as well as acquiring a detection signal of the light receiving section 7 at a predetermined timing within the predetermined time period T1, which is a light emission time period of each light emitting section 6.

In FIG. 4, it is shown that an amount of light received ALa is an amount of light detected by the light receiving section 7 when the light emitting section 6a emits a light, an amount of light received ALb is an amount of light detected by the light receiving section 7 when the light emitting section 6b emits a light, and an amount of light received ALc is an amount of light detected by the light receiving section 7 when the light emitting section 6c emits a light. The control section 11 can receive a detection signal of the light receiving section 7 and obtain information about an amount of light received corresponding to each light emitting section 6.

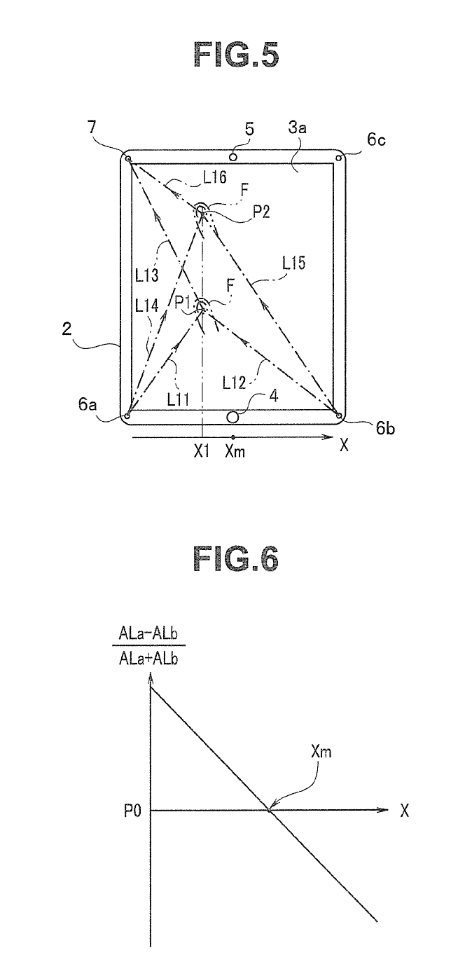

FIG. 5 is a diagram for illustrating optical paths through which lights emitted from the light emitting sections 6 are received by the light receiving section 7 seen from above the display area 3a of the tablet terminal 1. FIG. 5 is a diagram for illustrating estimation of a position of the finger F in the X direction.

In FIG. 5, a position P1 is a position slightly left in the X direction and slightly lower in the Y direction when seen from above the display area 3a of the tablet terminal 1. A position P2 is a position slightly left in the X direction and slightly upper in the Y direction. However, the X-direction positions X1 of the positions P1 and P2 are the same.

When the finger F is at the position P1 above and separated from the display area 3a not touching the display device 3 (that is, not touching the touch panel 13), a light which hits the finger F, is reflected by the finger F and enters the light receiving section 7, among lights emitted from the light emitting section 6a, passes through optical paths L11 and L13 shown in FIG. 5, and a light which hits the finger F, is reflected by the finger F and enters the light receiving section 7, among lights emitted from the light emitting section 6b, passes through optical paths L12 and L13 shown in FIG. 5.

When the finger F is at the position P2 above and separated from the display area 3a not touching the display device 3 (that is, not touching the touch panel 13), a light which hits the finger F, is reflected by the finger F and enters the light receiving section 7, among lights emitted from the light emitting section 6a passes through optical paths L14 and L16 shown in FIG. 5, and a light which hits the finger F, is reflected by the finger F and enters the light receiving section 7, among lights emitted from the light emitting section 6b, passes through optical paths L14 and L16 shown in FIG. 5.

Since the light receiving section 7 receives lights according to the light emission timings shown in FIG. 4 and outputs detection signals to the control section 11, the control section 11 acquires an amount-of-light-received signal corresponding to each light emitting section 6 from the light receiving section 7. The position of the finger F in the three-dimensional space is calculated as shown below.

From the amount of light received ALa of a reflected light of a light from the light emitting section 6a and the amount of light received ALb of a reflected light of a light from the light emitting section 6b, a rate Rx shown by a following equation (1) is calculated.

Rx=((ALa−ALb)/(ALa+ALb)) (1)

The rate Rx increases as the amount of light received ALa increases in comparison with the amount of light received ALb, and decreases as the amount of light received ALa decreases in comparison with the amount of light received ALb.

When the positions in the X direction are the same position, as shown by the positions P1 and P2, the rate Rx is the same.

FIG. 6 is a graph showing a relationship between the position of the finger F in the X direction and the rate Rx. In the X direction, the rate Rx increases when the finger F is near the light emitting section 6a, and the rate Rx decreases when the finger F is near the light emitting section 6b. At a central position Xm in the X direction on the display area 3a, the rate Rx is 0 (zero).

Therefore, the position of the finger F in the X direction can be estimated by the equation (1) based on the amounts of light received of reflected lights of lights emitted from the light emitting sections 6a and 6b.

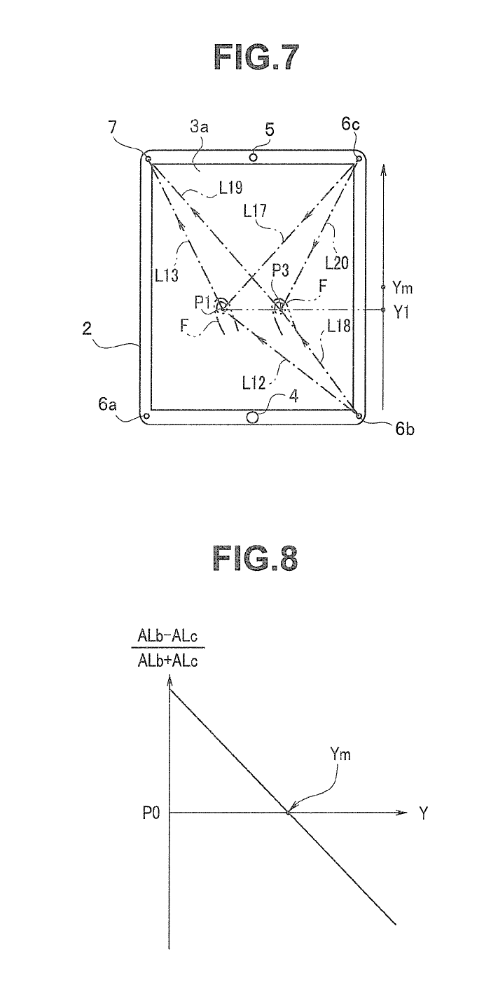

FIG. 7 is a diagram for illustrating optical paths through which lights emitted from the light emitting sections 6 are received by the light receiving section 7 seen from above the display area 3a of the tablet terminal 1. FIG. 7 is a diagram for illustrating estimation of the position of the finger F in the Y direction.

In FIG. 7, the position P1 is a position slightly left in the X direction and slightly lower in the Y direction when seen from above the display area 3a of the tablet terminal 1. A position P3 is a position slightly right in the X direction and slightly lower in the Y direction. However, the Y-direction positions Y1 of the positions P1 and P3 are the same.

When the finger F is at the position P1 above and separated from the display area 3a not touching the display device 3 (that is, not touching the touch panel 13), a light which hits the finger F, is reflected by the finger F and enters the light receiving section 7, among lights emitted from the light emitting section 6b, passes through the optical paths L12 and L13 similarly to FIG. 5, and a light which hits the finger F, is reflected by the finger F and enters the light receiving section 7, among lights emitted from the light emitting section 6c, passes through optical paths L17 and L13 shown in FIG. 7.

When the finger F is at the position P3 above and separated from the display area 3a not touching the display device 3 (that is, not touching the touch panel 13), a light which hits the finger F, is reflected by the finger F and enters the light receiving section 7, among lights emitted from the light emitting section 6b, passes through optical paths L18 and L19 shown in FIG. 7, and a light which hits the finger F, is reflected by the finger F and enters the light receiving section 7, among lights emitted from the light emitting section 6c, passes through optical paths L20 and L19 shown in FIG. 7.

Now, from the amount of light received ALb of a reflected light of a light from the light emitting section 6b and the amount of light received ALc of a reflected light of a light from the light emitting section 6c, a rate Ry shown by a following equation (2) is calculated.

Ry=((ALb−ALc)/(ALb+ALc)) (2)

The rate Ry increases as the amount of light received ALb increases in comparison with the amount of light received ALc, and decreases as the amount of light received ALb decreases in comparison with the amount of light received ALc.

When the positions in the Y direction are the same position, as shown by the positions P1 and P3, the rate Ry is the same.

FIG. 8 is a graph showing a relationship between the position of the finger F in the Y direction and the rate Ry. In the Y direction, the rate Ry increases when the finger F is near the light emitting section 6b, and the rate Ry decreases when the finger F is near the light emitting section 6c. At a central position Ym in the Y direction on the display area 3a, the rate Ry is 0 (zero).

Therefore, the position of the finger F in the Y direction can be estimated by the equation (2) based on the amounts of light received of reflected lights of lights emitted from the light emitting sections 6b and 6c.

Estimation of the position of the finger F in the Z direction will be described.

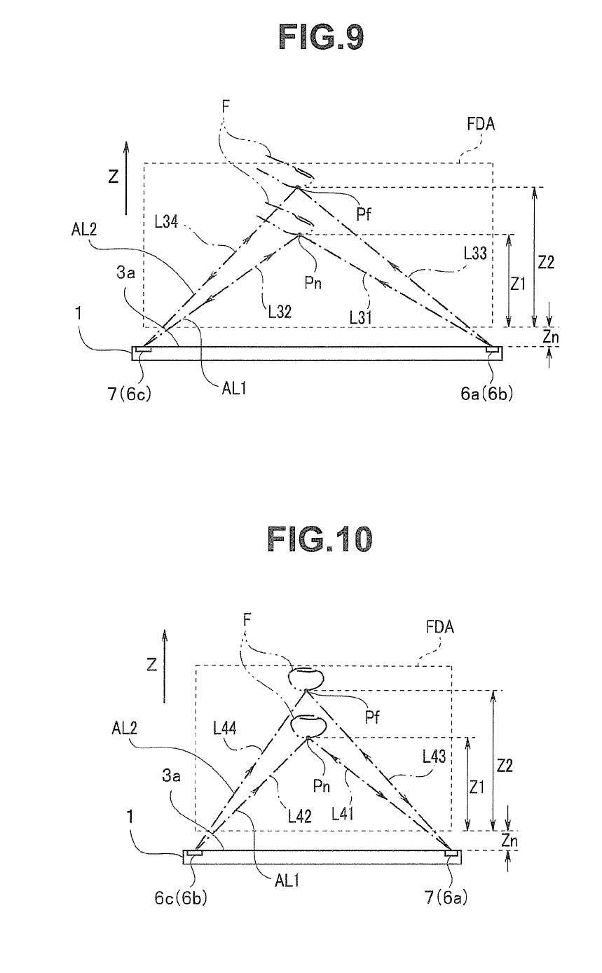

FIG. 9 is a diagram for illustrating the optical paths through which lights emitted from the light emitting sections 6 are received by the light receiving section 7 seen from a left side of the tablet terminal 1. FIG. 10 is a diagram for illustrating the optical paths through which lights emitted from the light emitting sections 6 are received by the light receiving section 7 seen from an upper side of the tablet terminal 1. In FIGS. 9 and 10, the upper surface of the tablet terminal 1 is the surface of the display area 3a.

A light with a predetermined wavelength is emitted at the light emission timing of each light emitting section 6. When a material body, the finger F here, is on the display area 3a, a reflected light reflected by the finger F enters the light receiving section 7. The amount of the reflected light entering the light receiving section 7 is inversely proportional to a square of a distance to the material body.

Note that, in FIGS. 9 and 10, a position on a surface of skin of the finger F nearest to the display area 3a will be described as the position of the finger F. In FIGS. 9 and 10, a position Pn of the finger F is a position separated from a lower surface of the motion judgment space FDA by a distance Z1, and a position Pf of the finger F is a position separated from the lower surface of the motion judgment space FDA by a distance Z2. The distance Z2 is longer than the distance Z1.

When the finger F is at the position Pn, a light emitted from each of the light emitting sections 6a and 6b passes through optical paths L31 and L32 in FIG. 9 and through optical paths L41 and L42 in FIG. 10, and then enters the light receiving section 7. When the finger F is at the position Pf, the light emitted from each of the light emitting sections 6a and 6b passes through optical paths L33 and L34 in FIG. 9 and through optical paths L43 and L44 in FIG. 10, and then enters the light receiving section 7. When the finger F is at the position Pn, a light emitted from the light emitting section 6c passes through the optical path L32 in FIG. 9 and through optical paths L41 and L42 in FIG. 10, and then enters the light receiving section 7. When the finger F is at the position Pf, the light emitted from the light emitting section 6c passes through the optical path L34 in FIG. 9 and through optical paths L43 and L44 in FIG. 10, and then enters the light receiving section 7.

When the case where the finger F is at the position Pn and the case where the finger F is at the position Pf, which is farther from the display area 3a than the position Pn, are compared, an amount of light AL1 at the time of the light emitted from the light emitting section 6 passing through the optical paths L31 and L32 and entering the light receiving section 7 is larger than an amount of light AL2 at the time of the light passing through the optical paths L33 and L34 and entering the light receiving section 7.

Accordingly, a sum SL of amounts of light received of lights from the three light emitting sections 6, which are received by the light receiving section 7, is determined by a following equation (3).

SL=(ALa+ALb+ALc) (3)

The amount of light of each of lights from the three light emitting sections 6 which have been reflected by the finger F and have entered the light receiving section 7 is inversely proportional to a square of a distance of the finger F in a height direction (that is, the Z direction) above the display area 3a.

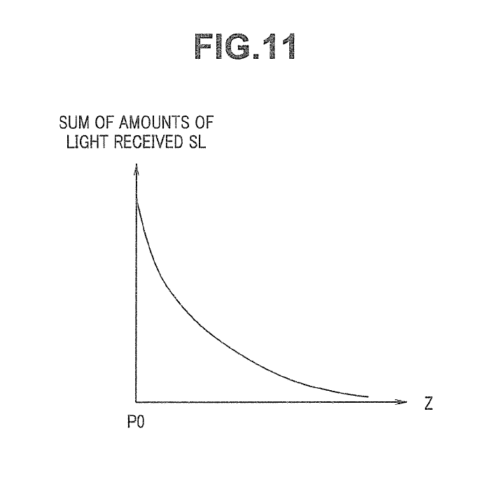

FIG. 11 is a graph showing a relationship between the position of the finger F in the Z direction and the sum SL of the three amounts of light received. In the Z direction, the sum SL of the three amounts of light received increases when the finger F is near the display area 3a, and the sum SL of the three amounts of light received decreases when the finger F is separated from the display area 3a.

Therefore, the position of the finger F in the Z direction can be estimated by the above equation (3) based on the amount of light received of reflected light of lights emitted from the light emitting sections 6a, 6b and 6c.

Note that, though the amounts of light emitted of the three light emitting sections 6 are the same value EL in the example stated above, the amounts of light emitted of the three light emitting sections 6 may differ from one another. In this case, corrected amounts of light received is used in the above-stated equation in consideration of difference among the amounts of light emitted, to calculate each of the percent and the sum of the amounts of light received.

As described above, by calculating a position on a two-dimensional plane parallel to the display surface and a position in a direction intersecting the display surface at a right angle based on three amounts of light obtained by detecting respective lights emitted from the three light emitting sections 6, from a material body, by the light receiving section 7, a position of the material body is detected. Especially, the position on the two-dimensional plane parallel to the display surface is determined from a position in a first direction on the two-dimensional plane calculated with values of a difference between and a sum of two amounts of light and a position in a second direction different from the first direction on the two-dimensional plane calculated with values of a difference between and a sum of two amounts of light.

Then, the position in the direction intersecting the display surface at a right angle is determined with a value of the sum of the three amounts of light. Note that the position in the Z direction may be determined from two amounts of light instead of using three amounts of light.

Therefore, each time the three amounts of light received ALa, ALb and ALc are obtained, the position of the finger F within the three-dimensional space can be calculated with the use of the above equations (1), (2) and (3). As shown in FIG. 4, position information about the finger F within the three-dimensional space is calculated at each of the timings t1, t2, . . . .

Since the tablet terminal 1 of the present embodiment has a touch panel function and a function of detecting a finger position within a three-dimensional space, it is possible to give a desired operation specification to the tablet terminal 1 by an intuitive finger operation by the user (as if reading an analog book).

Note that, though the position Pf and movement track of the fingers F in the motion judgment space FDA are detected in the present embodiment and other (second and third) embodiments, detection of the position Pf and movement track of the finger F is not limited to the inside of the motion judgment space FDA as described above and may be performed in a larger space which includes the motion judgment space FDA. That is, the position Pf and movement track of the finger F in a third-dimensional space where detection by the three light emitting sections 6 and the light receiving section 7 is possible may be detected.

Furthermore, the motion judgment space FDA and the larger space which includes the motion judgment space FDA do not have to be cuboid-shaped as stated above.

### Operation

The present embodiment relates to a picking-up motion of fingers. A page-turning operation will be described as an example of the picking-up motion of fingers.

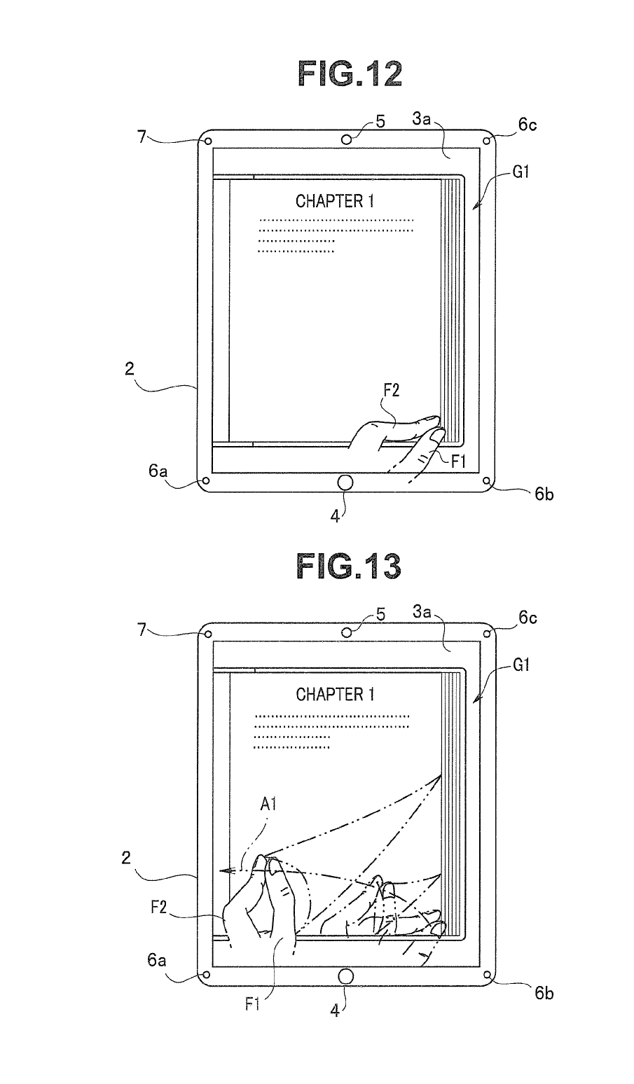

FIG. 12 is a diagram showing an example of displaying an electronic book. An image screen of the electronic book is displayed in the display area 3a of the display device 3 of the tablet terminal 1. Electronic book application software (hereinafter referred to as an electronic book application) and book data are stored in the storage section 15. When the user activates the electronic book application and specifies a desired book, a page image of the book is displayed in the display area 3a of the display device 3. The user can read the book by turning pages at times.

In the present embodiment, description will be made on a case where the user gives a command instruction to perform a page turning operation to such an electronic book application by an intuitive operation of performing a motion like picking up an end of a page to turn the page.

The electronic book application is software for, by reading out image data of a book and displaying a page image on the display device 3, making it possible for a user to read the book.

An electronic book image G1 shown in FIG. 12 shows a right-side page of an opened book. Here, when the user finishes reading the page and causes a next page to be displayed, the user can give a page turning command to the electronic book application by performing a motion or gesture like turning a page with fingers.

FIG. 12 is a diagram showing a case where the user's fingers F touch a lower right part of the page displayed in the display area 3a and perform a motion of picking up the page. FIG. 12 shows a state in which the user is performing a motion of picking up the lower right part of the page with the thumb F1 and the forefinger F2. FIG. 13 is a diagram showing a state in which the user performs a motion of detaching the thumb F1 and the forefinger F2 from the display area 3a and moving the two fingers F1 and F2 toward an upper left direction, that is, a gesture of turning the page.

By performing such a finger motion, the user can give the page turning command to the electronic book application of the tablet terminal 1. Upon receiving the page turning command, the electronic book application executes processing for displaying an object of a next page image in the display area of the display device 3 instead of an object of the page currently displayed.

FIG. 13 shows that the two fingers F1 and F2 move along a two-dot chain line arrow A1. Upon receiving the page turning command, the electronic book application displays the next page by turning the page in an animation display as if the page were turned in an actual book.

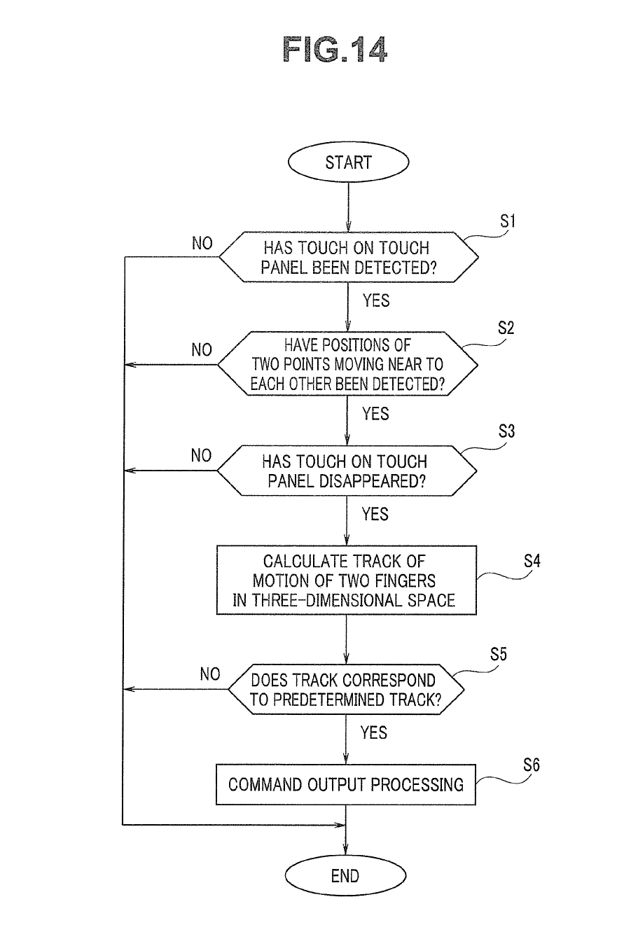

FIG. 14 is a flowchart showing an example of a flow of a command judging process by the touch panel function and the three-dimensional space position detecting function. A command judging process program in FIG. 14 is stored in the storage section 15 or the ROM. When the electronic book application is being executed by the CPU of the control section 11, the command judging process program is read out and executed by the CPU of the control section 11. Note that the command judging process program may be a part of the electronic book application or may be a part of an input processing program of the tablet terminal 1.

By monitoring a touch position signal outputted from the touch panel 13, the control section 11 judges whether a touch on the touch panel 13 has been detected or not (S1). If a touch on the touch panel 13 is not detected (S1: NO), the process does not do anything at all.

If a touch on the touch panel 13 is detected (S1: YES), the control section 11 judges whether positions of two points moving near to each other have been detected or not (S2). That is, it is judged whether or not two points have been touched and the two points move near to each other. If two points moving near to each other have not been detected (S2: NO), the process does not do anything at all.

By the above processing of S1 and S2, detection in the case of a touch motion like a picking-up motion on the touch panel 13 with the fingers F1 and F2 in FIG. 12 is performed.

If positions of two points moving near to each other have been detected (S2: YES), the control section 11 judges whether the touch on the touch panel 13 has disappeared or not (S3). If the touch on the touch panel 13 does not disappear (S3: NO), the process does not do anything at all.

When the touch on the touch panel 13 disappears (S3: YES), the control section 11 calculates a track of a motion within a predetermined time period of the fingers F1 and F2 which have left the touch panel 13 (S4). The processing of S4 constitutes a position detecting section configured to detect a position of a material body in a three-dimensional space opposite to the display surface of the display device 3.

Detection of the motion of the fingers F1 and F2 at S4 can be determined from the above-stated equations (1) to (3). That is, by detection of positions of the fingers F1 and F2 in the motion judgment space FDA within a predetermined time period, for example, within one second is executed a predetermined number of times, a motion track of the fingers F1 and F2 is calculated. The calculated track is constituted by information about multiple positions of the fingers F1 and F2 detected within the motion judgment space FDA from vicinity of a central position of a line connecting two points at the time of the two fingers F1 and F2 leaving the touch panel 13.

Note that, because of reflected lights of lights from the two fingers F1 and F2, the track of the position is calculated with a hand including the two fingers F1 and F2 as one material body.

Next, it is judged whether the calculated track corresponds to a predetermined track or not (S5). The predetermined track is, for example, a track similar to a track indicated by the arrow A1 in the motion judgment space FDA as shown in FIG. 13. The predetermined track is a track assumed when a person turns a page on an image of an electronic book as shown in FIG. 12 or determined by a test, and the predetermined track is set or written in the command judging process program. FIG. 13 shows a state in which a left hand which includes the two fingers F1 and F2 moves toward an upper left direction as indicated by the arrow A1, from a state of touching a lower right of the display area 3a as if the left hand were turning a page. Therefore, the predetermined track is a track similar to a track of a movement within the three-dimensional motion judgment space FDA, from vicinity of a lower position of a page end at lower right of a page image displayed in the display area 3a toward an upper direction of a left end of the page image.

At S5, it is judged whether or not the calculated track corresponds to the predetermined track within predetermined tolerable limits. If the calculated track corresponds to the predetermined track, the control section 11 executes command output processing for generating a predetermined command, that is, a page turning command and giving the command to the electronic book application (S6).

Therefore, the processing of S5 and S6 constitutes a command generating section configured to generate a predetermined command for causing predetermined processing to be executed on the basis of touch position information about a touch position on the touch panel 13 by a touch operation on the touch panel 13 and position-in-space information about a material body in the three-dimensional space detected by the position detecting section of S4 after the touch panel 13 is touched.

The touch position information is position information about two points of two fingers moving near to each other; the position-in-space information is information indicating a track of a material body moving from a central (or vicinity) position between the two positions moving near to each other; and the predetermined process is processing for moving an image displayed on the display device 3 like turning the image.

As a result, the electronic book application reads out a page image of a next page of the page currently displayed and displays the page image in the display area 3a. When the calculated track does not correspond to the predetermined track (S5: NO), the process does not do anything at all.

Thus, in an electronic book, the user can specify the page turning command by a natural and intuitive finger motion of turning a page by touching the touch panel and performing a gesture within a three-dimensional space.

The above example shows a page turning operation by a picking-up motion of fingers and movement of the fingers in a three-dimensional space. The picking-up motion of fingers and the movement of the fingers in a three-dimensional space can be also used for outputting an animation motion command in a picture book or the like.

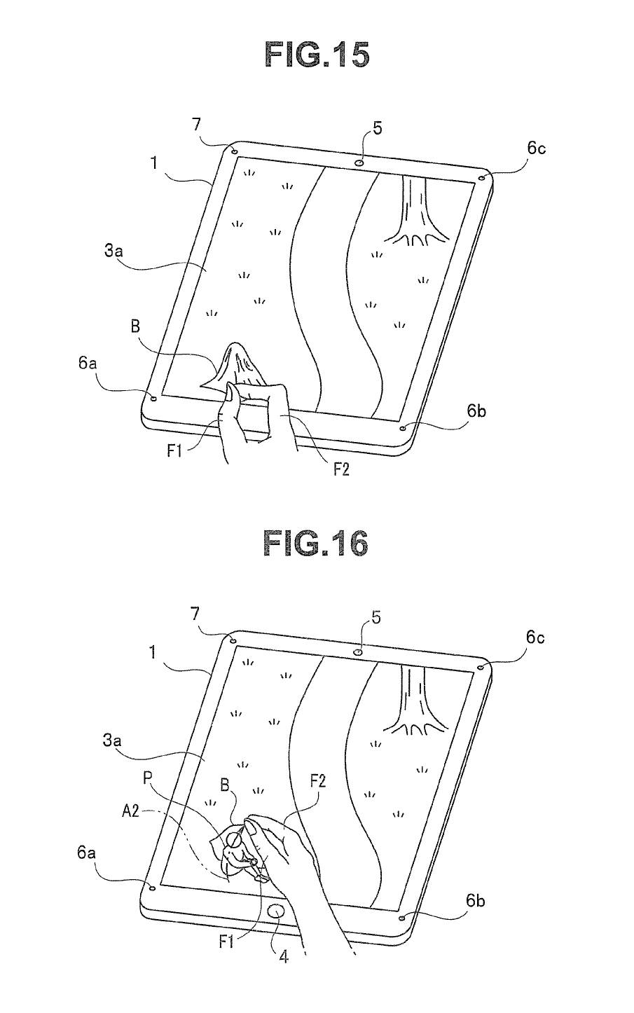

FIGS. 15 and 16 are perspective views of the tablet terminal 1 with one scene of an electronic picture book displayed on the display device 3.

An electronic picture book is provided with an animation function corresponding to a command. According to the animation function, an image to be displayed changes according to a predetermined command input. A command input by the touch panel function and three-dimensional space position detecting function stated above can be applied to a method for such a command input for the animation function.

FIG. 15 shows a state in which a material body covered with a cloth B exists in a picture, and the user picks up an end part of the cloth B, for example, with the thumb F1 and the forefinger F2 while touching the touch panel 13.

When, from that state, the user detaches the two fingers from the touch panel 13 and performs a motion like taking off the cloth B, a command for taking off the cloth B is generated and outputted. As a result, the cloth B is taken off by the animation function, and the image changes so that the covered material body can be seen.

FIG. 16 shows a state in which, when the two fingers F1 and F2 move as indicated by a two-dot chain line arrow A2, the cloth B is taken off, and a covered person P appears.

A command instruction input for the animation function as shown in FIGS. 15 and 16 is also realized by the process shown in FIG. 14.

Two points moving near to each other on the touch panel 13 are detected by S1 and S2. Through S3 to S5, it is judged whether or not a track of a motion of the fingers in the three-dimensional space after leaving the touch panel 13 corresponds to a predetermined track corresponding to the animation function command of taking off the cloth B.

The predetermined track corresponding to taking off is, for example, a track of a motion of a material body from a position touched on the touch panel 13 toward an obliquely upper direction in the three-dimensional space and is set or written in the command judging process program in advance.

When the track of the motion of the fingers after leaving the touch panel 13 corresponds to such a predetermined track, it is judged to be the command for executing the animation function of taking off the cloth B. The control section 11 specifies the command to the electronic picture book application software. As a result, the electronic picture book application software executes animation function processing for displaying an image showing a changed image as in FIG. 16 in the display area 3a.

As described above, according to the present embodiment, it is possible to provide an information terminal apparatus capable of specifying a command, a taking-off motion command here, by a more intuitive operation without necessity of complicated processing.

Note that, though the above examples are examples of a page turning function of an electronic book and an animation function of an electronic picture book, inputting a command instruction by a motion of performing picking-up with fingers and moving the fingers as stated above is also applicable on a game image also.

### Second Embodiment

The command specified in the first embodiment is a command for a motion of turning or taking off an object by a motion of touching the touch panel 13 like performing picking-up with fingers and then detaching two fingers from the touch panel 13. A command specified in a second embodiment is a command for enlargement and reduction of an object by a motion of moving two fingers in a state of the two fingers touching the touch panel 13, and detaching the two fingers from the touch panel 13.

Since a configuration of a tablet terminal of the present invention is the same as the tablet terminal 1 described in the first embodiment, same components are given same reference numerals, and description of each of the components will be omitted. Only different components will be described. That is, a hardware configuration of the tablet terminal of the present invention, and functions of detection of a touch position on the touch panel 13 and detection of a material body position in a three-dimensional space by the three light emitting sections 6 and the light receiving section 7 are the same as those of the tablet terminal 1 of the first embodiment, and a command judging function is different from the command judging function of the first embodiment.

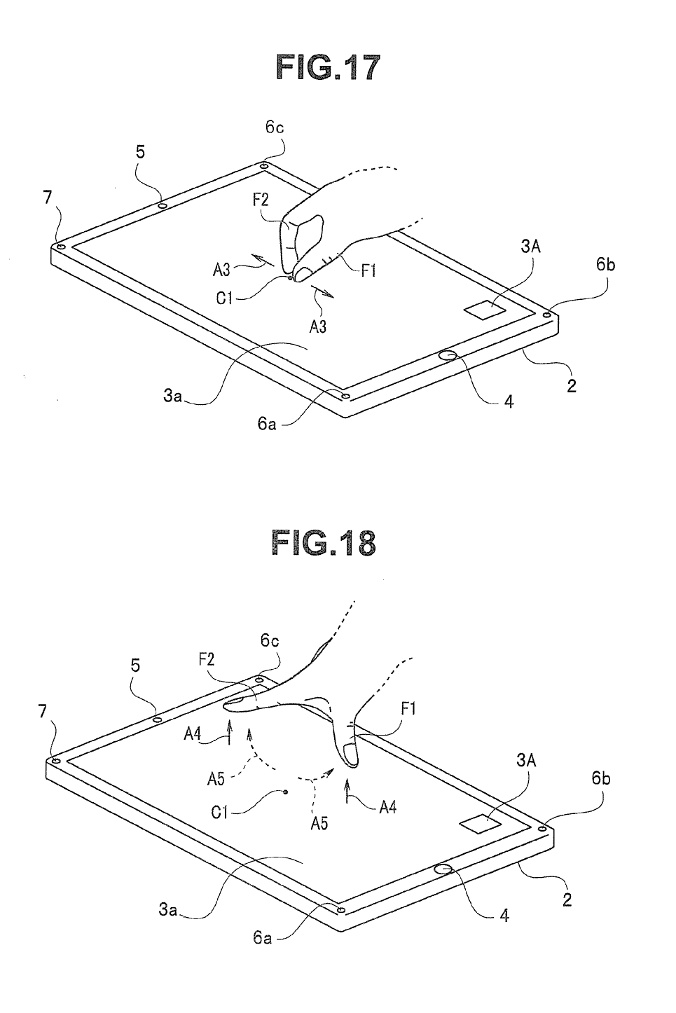

FIGS. 17 and 18 are diagrams for illustrating a method for specifying a command for performing enlarged display of an object displayed in the display area 3a.

In FIG. 17 and the like, an object such as an image is displayed in the display area 3a. Furthermore, a predetermined button 3A is also displayed in the display area 3a together with the displayed object. The button 3A is a button for specifying stopping of a zoom operation.

First, as shown in FIG. 17, the user causes two fingers, the thumb F1 and the forefinger F2 here to be positioned at a central position C1 of an object on the display area 3a which he wants to enlarge, in a state of the thumb F1 and the forefinger F2 touching the touch panel 13.

From that state, after performing a pinch out motion of sliding the two fingers F1 and F2 a little on the touch panel 13 while opening the two fingers F1 and F2 so that they move separated from each other, the user detaches the two fingers F1 and F2 from the display device 3. After a motion of moving the two fingers F1 and F2 on the touch panel 13 in a direction indicated by an arrow A3 while causing the two fingers F1 and F2 to be touching the touch panel 13 as shown in FIG. 17, the two fingers F1 and F2 leave the touch panel 13 into a direction indicated by an arrow A4 (that is, into a Z direction) as shown in FIG. 18. That is, the two fingers F1 and F2 move in the Z direction while being opened as indicated by dotted lines A5.

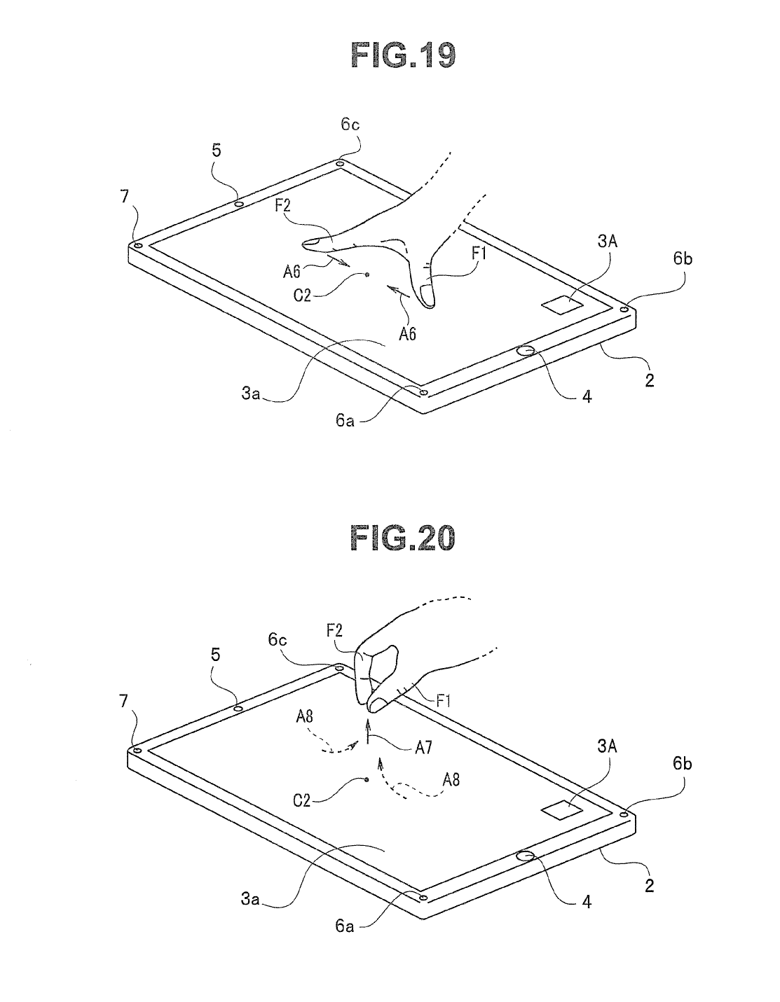

FIGS. 19 and 20 are diagrams for illustrating a method for specifying a command for performing reduced display of an object displayed in the display area 3a.

As shown in FIG. 19, the user causes two fingers, the thumb F1 and the forefinger F2 here, to be in a state of touching the touch panel 13, being separated from each other, with a central position C2 of an object on the display area 3a which he wants to reduce positioned at a center of a line connecting two points at which the thumb F1 and the forefinger F2 are touching the touch panel 13.

From that state, after performing a pinch in motion of sliding the two fingers F1 and F2 a little on the touch panel 13 while closing the two fingers F1 and F2 so that they move near to each other, the user detaches the two fingers F1 and F2 from the display device 3. After moving the two fingers F1 and F2 on the touch panel 13 in a direction indicated by an arrow A6 while causing the two fingers F1 and F2 to be touching the touch panel 13 as in FIG. 19, the two fingers F1 and F2 leave the touch panel 13 into a direction indicated by an arrow A7 (that is, into the Z direction) as shown in FIG. 20. That is, the two fingers F1 and F2 move in the Z direction while being closed as indicated by dotted lines A8.

By the motion of two fingers as described above, the user can specify a command for enlarged and reduced display of an object, to the tablet terminal 1.

Note that, in the above example, though the motion of two fingers as shown in FIGS. 17 and 18 is a motion indicating specification of an enlargement command for enlarging a displayed object, and the motion of two fingers as shown in FIGS. 19 and 20 is a motion indicating specification of a reduction command for reducing a displayed object, it is also possible that the motion of two fingers as shown in FIGS. 17 and 18 is the motion indicating specification of the reduction command for reducing a displayed object, and the motion of two fingers as shown in FIGS. 19 and 20 is the motion indicating specification of the enlargement command for enlarging a displayed object.

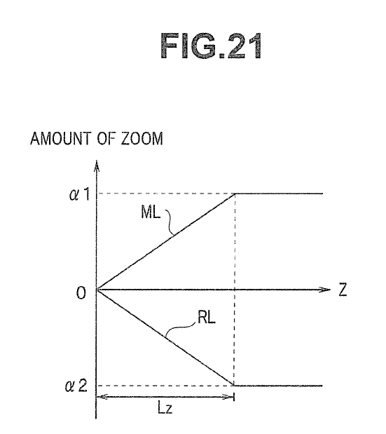

FIG. 21 is a diagram showing an amount of zoom in enlargement and reduction. In FIG. 21, a horizontal axis indicates a position of a finger in the Z direction; a vertical axis indicates the amount of zoom of enlargement and reduction; a line ML indicates the amount of zoom of an enlargement rate; and a line RL indicates the amount of zoom of a reduction rate. As calculated positions of the two fingers in the Z direction move separated from the display area 3a in the motion judgment space FDA, the enlargement rate increases, and the reduction rate decreases.

That is, in the case of enlargement, an amount of zoom ML, which is the enlargement rate, gradually increases as the two fingers move separated from the display device 3 in the Z direction after entering the motion judgment space FDA. When the two fingers go out beyond the range of the motion judgment space FDA in the Z direction, the amount of zoom ML is fixed at an enlargement rate α1 and does not change. In the case of reduction, an amount of zoom RL, which is the reduction rate, gradually decreases as the two fingers move separated from the display device 3 in the Z direction after entering the motion judgment space FDA. When the two fingers go out beyond the range of the motion judgment space FDA in the Z direction, the amount of zoom RL is fixed at a reduction rate α2 and does not change.

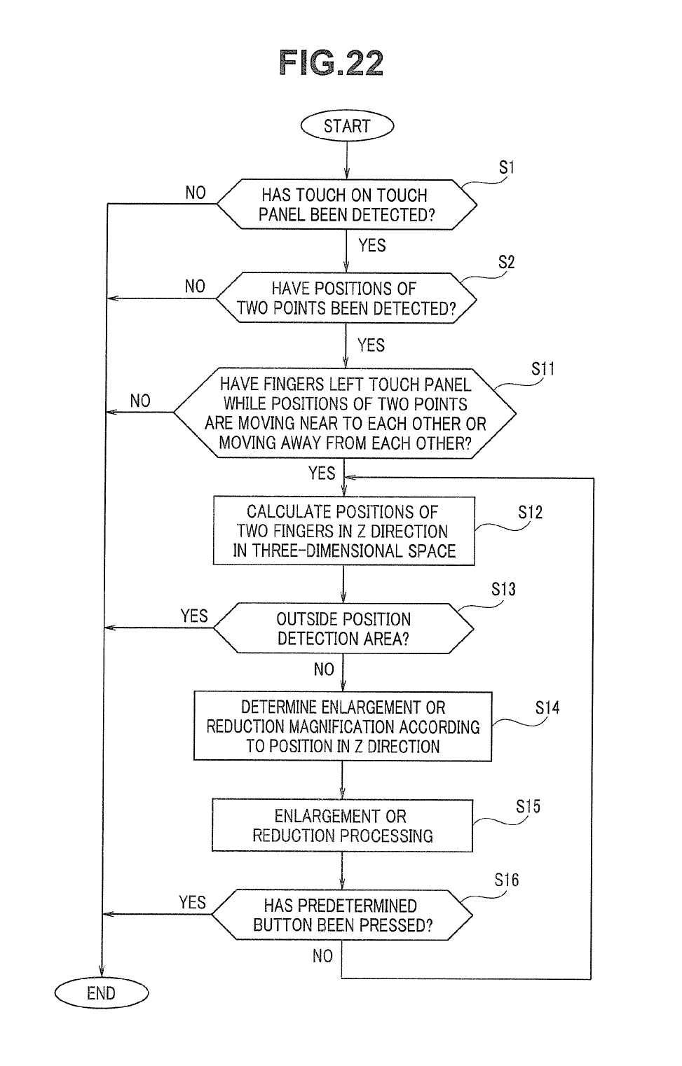

FIG. 22 is a flowchart showing an example of a flow of a command judging process for performing enlarged and reduced display of an object by a touch panel function and a three-dimensional space position detecting function. In FIG. 22, same processing as processing in FIG. 14 is given a same step number, and description thereof will be simplified.

A command judging process program in FIG. 22 is stored in the storage section 15 or the ROM. When an object is displayed on the display device 3, the command judging process program is read out and executed by the CPU of the control section 11.

By monitoring a touch position signal outputted from the touch panel 13, the control section 11 judges whether a touch on the touch panel 13 has been detected or not (S1).

If a touch on the touch panel 13 is detected (S1: YES), the control section 11 judges whether positions of two points have been detected or not (S2).

By the above processing of S1 and S2, detection in the case of a touch on the touch panel 13 with the fingers F1 and F2 in FIG. 12 is performed.

When the two point are touched (S2: YES), the control section 11 judges whether or not the touch on the touch panel 13 has faded out, that is, the touch with the two fingers on the touch panel 13 has faded out while the detected positions of the two points are moving near to each other or moving separated from each other (S11). If the touch on the touch panel 13 does not fade out while the positions of the two points are moving near to each other or moving separated from each other (S11: NO), the process does not do anything at all.

The judgment of S11 is judgment of the motions described through FIGS. 17 to 20. It is judged whether the two fingers F1 and F2 have left the touch panel 13 while being opened as shown in FIGS. 17 and 18 or have left the touch panel 13 while being closed as shown in FIGS. 19 and 20.

In the case of YES at S11, the control section 11 calculates positions of the two fingers in the Z direction in the three-dimensional space which includes the motion judgment space FDA (S12). The processing of S12 constitutes a position detecting section configured to detect a position of a material body in the three-dimensional space opposite to the display surface of the display device 3.

The positions of the two fingers in the Z direction at S12 can be determined from the equation (3) as stated above.

Next, it is judged whether the two fingers are outside the motion judgment space FDA or not (S13).

If the two fingers are outside the motion judgment space FDA (S13: YES), the process ends. That is, when a position of a material body in the three-dimensional space is beyond a predetermined position, an amount of zoom is fixed to a value of the amount of zoom then.

If the two fingers are not outside the motion judgment space FDA (S13: NO), the control section 11 determines magnification of enlargement or reduction according to the calculated positions in the Z direction (S14). For example, in the case of the enlargement command shown in FIGS. 17 and 18, it is written in the command judging process program that the enlargement magnification increases as distance between the two fingers and the display device 3 increases, according to the positions in the Z direction in the motion judgment space FDA, as shown by the amount of zoom ML in FIG. 21. Similarly, in the case of the reduction command shown in FIGS. 19 and 20, it is written in the command judging process program that the reduction magnification increases as the distance between the two fingers and the display device 3 increases, according to the position in the Z directions in the motion judgment space FDA, as shown by the amount of zoom RL in FIG. 21.

The control section 11 performs enlargement or reduction processing for generating and executing a command for enlarged or reduced display of an object with the magnification determined at S14 (S15). In the enlargement or reduction processing, the control section 11 calculates the point C1 or C2 stated above from the positions of the two points detected at S2 and executes the enlarged or reduced display processing with the calculated point C1 or C2 as a center.

Furthermore, the control section 11 judges whether the button 3A on the display area 3a has been touched or not (S16). If the button 3A has been touched (S16: YES), the process ends. That is, if a predetermined touch operation is performed on the touch panel 13, execution of zoom processing is ended. As a result, an object displayed in the display area 3a of the display device 3 is in a state of being fixed with the amount of zoom then. That is, for example, even if two fingers of a right hand is within the motion judgment space FDA, the object is fixed with a size then when the button 3A is touched by a finger of a left hand.

Therefore, the processing of S13 to S16 constitutes a command generating section configured to generate a predetermined command for executing predetermined processing on the basis of touch position information about touch positions on the touch panel 13 by a touch operation on the touch panel 13 and position-in-space information about a material body in the three-dimensional space detected by the position detecting section of S12 after the touch panel 13 is touched.

The touch position information is position information about two points of two fingers moving near to each other or moving separated from each other; the position-in-space information is information about a position of a material body in the three-dimensional space in a direction intersecting the display space of the display device 3 at right angles; and the predetermined processing is zoom processing for zooming an image displayed on the display device 3 with an amount of zoom determined on the basis of the position-in-space information.

If the button 3A has not been touched (S16: NO), the process returns to S12.

Therefore, when the two fingers move in the Z direction, enlargement or reduction of an object is continuously performed according to a position in the Z direction, as far as the two fingers exist within the motion judgment space FDA. Then, if the two fingers are outside the motion judgment space FDA, the enlargement or reduction processing is not executed any more.

Thus, when a finger motion as shown in FIGS. 17 and 18 is detected, a command for performing enlarged display of an object with the point C1 as a center is executed; and, when a finger motion as shown in FIGS. 19 and 20 is detected, a command for performing reduced display of an object with the point C2 as a center is executed.

As a result, the object displayed on the display device 3 is enlargedly or reducedly displayed.

An operation for zooming by a conventional touch panel requires frequent pinch operations to change the amount of zoom. However, an operation for zooming of the present embodiment can change the amount of zoom by changing a finger position within the motion judgment space FDA and does not require the frequent pinch operations which are conventionally required.

Accordingly, the user can specify the command for enlargement and reduction of an object such as an image by natural and intuitive motions of two fingers on the tablet terminal 1.

As described above, according to the present embodiment, it is possible to provide an information terminal apparatus capable of specifying a command, here the enlargement and reduction commands, by a more intuitive operation without necessity of complicated processing.

### Third Embodiment

The commands specified in the first and second embodiments are the turning or taking-off motion command and the enlargement/reduction command, respectively. A command specified in a third embodiment is a command for a predetermined motion by, while touching the touch panel 13 with one or multiple fingers of one hand, causing the other hand or a different finger to make a motion in a three-dimensional space.

Since a configuration of a tablet terminal of the present invention is the same as the tablet terminal 1 described in the first embodiment, same components are given same reference numerals, and description of each of the components will be omitted. Only different components will be described. That is, a hardware configuration of the tablet terminal of the present invention, and functions of detection of a touch position on the touch panel 13 and detection of a material body position in a three-dimensional space by the three light emitting sections 6 and the light receiving section 7 are the same as those of the tablet terminal 1 of the first embodiment, and a command judging function is different from the command judging function of the first embodiment.

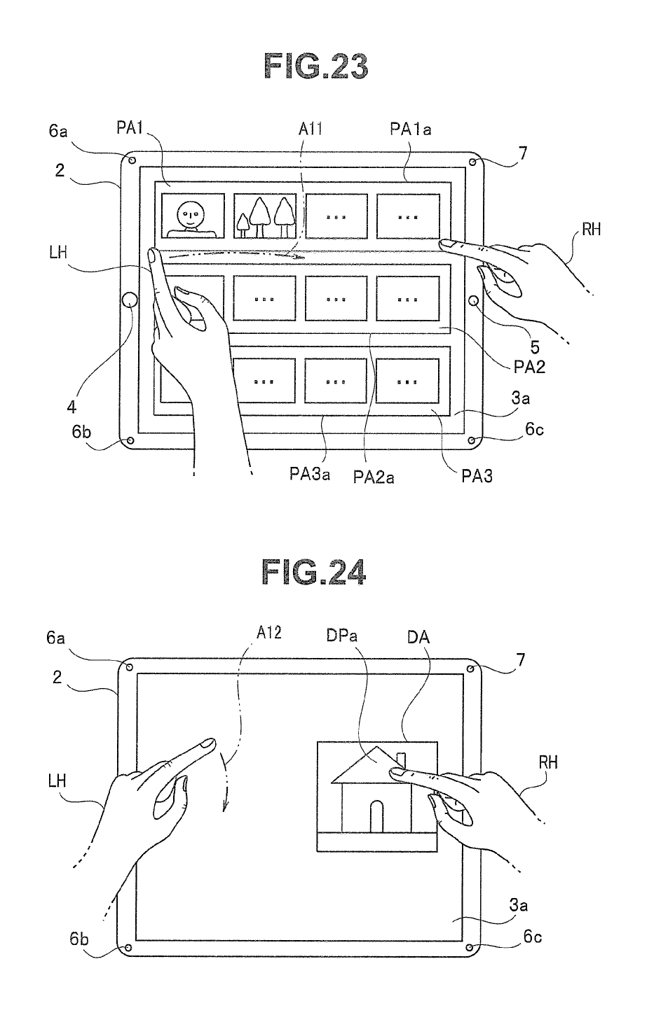

FIGS. 23 to 26 are diagrams for illustrating a method for specifying the command of the third embodiment.

FIG. 23 is a diagram for illustrating a method for specifying a command for scrolling. FIG. 23 is a diagram showing an example of displaying an image displayed on the display device 3 of the tablet terminal 1. Thumbnail images of multiple images of three respective photograph albums PA1, PA2 and PA3 are displayed in the display area 3a of the display device 3 of the tablet terminal 1. Image data of multiple photograph albums are stored in the storage section 15, and the control section 11 displays images of three photograph albums in the display area 3a by a predetermined picture browsing program. Four thumbnail images are displayed in a horizontal direction side by side in image display areas PA1a, PA2a and PA3a for the respective photograph albums. In order to see other thumbnail images which are not displayed, the user scrolls the displayed four thumbnail images in the horizontal direction, and, thereby, the user can see the other thumbnail images.

In FIG. 23, description will be made on a case of scrolling the thumbnail images of the album PA1 displayed at the top, among the three photograph albums (hereinafter referred to simply as albums) PA1, PA2 and PA3 displayed in the display area 3a, as an example.

The user selects an album for which scrolling is to be performed, with one hand (a right hand RH here). The selection is performed by touching anywhere in an image display area of an album to be selected. FIG. 23 shows that the right hand RH touches the image display area PA1a for the album PA1 at the top. The touch on the image display area PA1a is detected by the touch panel 13.

Then, when the user performs a motion of moving a left hand LH from left to right within the motion judgment space FDA in a state of the right hand touching the image display area PA1a, the finger motion within the motion judgment space FDA is detected.

The control section 11 judges whether or not the detected finger motion corresponds to a predetermined motion, for example, movement from a left direction to a right direction or movement from the right direction to the left direction. If the detected finger motion corresponds to the predetermined motion, the control section 11 scrolls the thumbnail images of the selected album PA1 in a predetermine direction to change thumbnail images to be displayed on the image display area PA1a. Since the left hand LH moves from the left direction to the right direction as indicated by a two-dot chain line arrow A11 in FIG. 23, the control section 11 executes processing for a motion of scrolling the images displayed in the image display area PA1a to the right.

Thus, the user can easily and intuitively perforin a scroll operation (as if reading an analog book) on the tablet terminal 1.

FIG. 24 is a diagram for illustrating a method for specifying a command for changing shade of color. FIG. 24 is a diagram showing an example of displaying an image displayed on the display device 3 of the tablet terminal 1. A picture DA is displayed in the display area 3a of the display device 3 of the tablet terminal 1. The user can draw a picture in the display area 3a of the tablet terminal 1 using drawing software. The picture DA shown in FIG. 24 is a picture of a house.

In the case of coloring the picture DA using the drawing software, the user specifies an area to be colored and specifies a coloring command. Then, the control section 11 can color the specified area with the specified color. Furthermore, it is possible to perform change processing for changing shade of the used color.

In FIG. 24, description will be made on a case of changing shade of color of a triangular area DPa indicating a roof of the house in the picture DA displayed in the display area 3a, as an example.

The user specifies an area for which the shade of color is to be changed, with one hand (the right hand RH here). FIG. 24 shows that a forefinger of the right hand RH touches the triangular area DPa indicating the roof of the house. The touch on the triangular area DPa is detected by the touch panel 13.

Then, when the user performs, for example, a motion of moving the left hand LH from upward to downward or from downward to upward within the motion judgment space FDA in the state of the right hand RH touching the triangular area DPa, the finger motion within the motion judgment space FDA is detected on the tablet terminal 1.

The control section 11 judges whether or not the detected finger motion corresponds to a predetermined motion, for example, movement from upward to downward indicating an instruction to lighten color or movement from downward to upward indicating an instruction to darken color. If the detected finger motion corresponds to the predetermined motion, the control section 11 performs processing for changing the shade of color within the selected triangular area DPa. Since a forefinger of the left hand LH moves from upward to downward as indicated by a two-dot chain line arrow A12 in FIG. 24, the control section 11 executes the change processing for changing shade of color so that the color in the triangular area DPa is lightened.

Thus, the user can easily and intuitively perform the processing for changing shade of color on the tablet terminal 1.

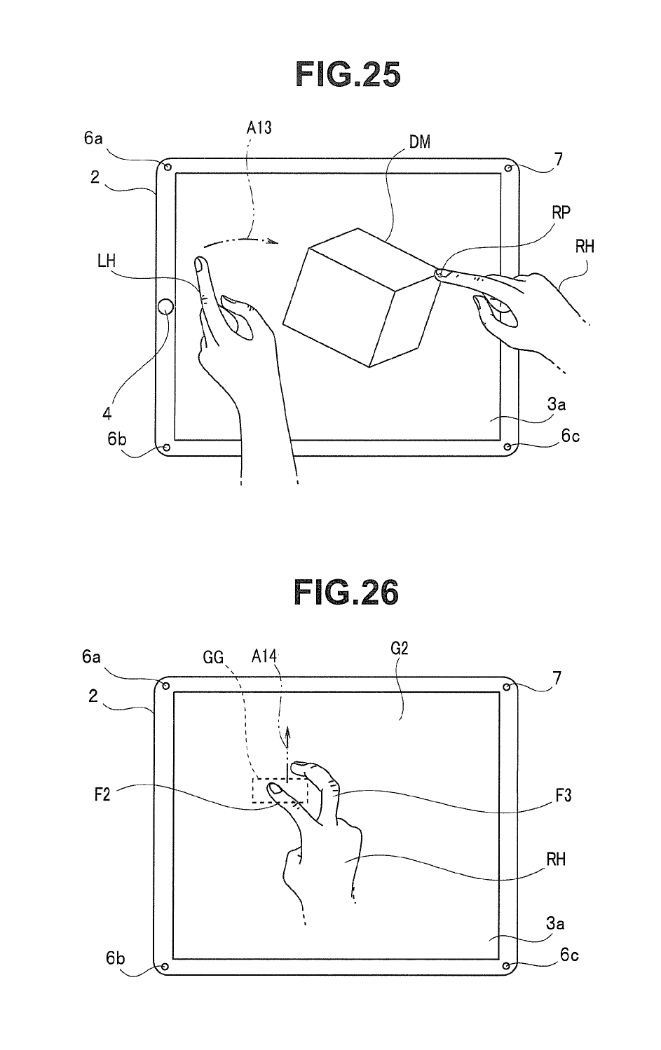

FIG. 25 is a diagram for illustrating a method for specifying rotation of a figure. FIG. 25 shows an example of displaying an image displayed on the display device 3 of the tablet terminal 1. A cuboid solid figure DM is displayed in the display area 3a of the display device 3 of the tablet terminal 1. The solid figure DM is, for example, an image created by the user using 3D CAD software.

Usually, by rotating the solid figure DM created and displayed with the CAD software in a three-dimensional space and seeing the created solid figure DM from around the solid figure DM, the user can confirm external appearance and the like of the solid figure DM. For example, by specifying one point on the solid figure DM and performing a predetermined operation, the control section 11 executes processing for rotating the solid figure DM.

In FIG. 25, description will be made on a case of specifying one point of the solid figure DM displayed in the display area 3a to rotate the solid figure DM, as an example.

The user specifies a position RP to be a center of rotation, with one hand (the right hand RH here). In FIG. 25, the forefinger of the right hand RH specifies a point RP on a right end of the solid figure DM. The touch on the point RP is detected by the touch panel 13.

Then, when the user performs, for example, a motion of moving the left hand LH from the left direction to the right direction or from the right direction to the left direction within the motion judgment space FDA in the state of the right hand RH touching the point RP, the finger motion within the motion judgment space FDA is detected.

The control section 11 judges whether or not the detected finger motion corresponds to a predetermined motion, for example, movement from a left direction to a right direction or movement from the right direction to the left direction. If the detected finger motion corresponds to the predetermined motion, the control section 11 performs rotation processing for rotating the solid figure DM by a predetermined amount with the selected, that is, specified position RP as a center. Since the forefinger of the left hand LH moves from the left direction to the right direction as indicated by a two-dot chain line arrow A13 in FIG. 25, the control section 11 executes rotation processing for rotating the solid figure DM by a predetermined amount into a left direction with the position RP as a center.

Thus, the user can easily and intuitively perform figure rotation processing on the tablet terminal 1.

FIG. 26 is a diagram for illustrating a method for specifying scrolling of a screen excluding an image at a specified position. Various kinds of screens are displayed in the display area 3a of the display device 3 of the tablet terminal 1. When all range of each screen is not displayed within the display area 3a, the user can move a part of the screen which is not displayed, into the display area by scrolling the screen.

In FIG. 26, description will be made on a case of moving a middle finger F3 of the right hand RH to perform screen scrolling in a state of the forefinger F2 of the right hand RH touching a part of a screen displayed in the display area 3a, as an example.

The user specifies an image area to be excluded from a scroll target with the forefinger F2 of one hand (the right hand RH here). In FIG. 26, the forefinger F2 of the right hand RH specifies a partial area GG (indicated by a dotted line) of a screen G2 displayed in the display area 3a. The touch on the partial area GG is detected by the touch panel 13.

Then, when the user performs, for example, a motion of moving a fingertip of another finger (the middle finger F3 here) of the right hand RH in a scrolling direction within the motion judgment space FDA in the state of one finger (the forefinger F2 here) of the right hand RH touching the partial area GG, the finger motion within the motion judgment space FDA is detected on the tablet terminal 1.

The control section 11 judges the motion of the finger (the middle finger F3) detected within the motion judgment space FDA and performs processing for scrolling the screen G2 excluding the area GG, into the judged motion direction. Since, in FIG. 26, the middle finger F3 of the right hand RH moves from downward to upward relative to a page surface of FIG. 26 as indicated by a two-dot chain line arrow A14, the control section 11 executes processing for scrolling the screen G2 (excluding the area GG) upward.

Thus, the user can easily and intuitively perform scroll processing on the tablet terminal 1.

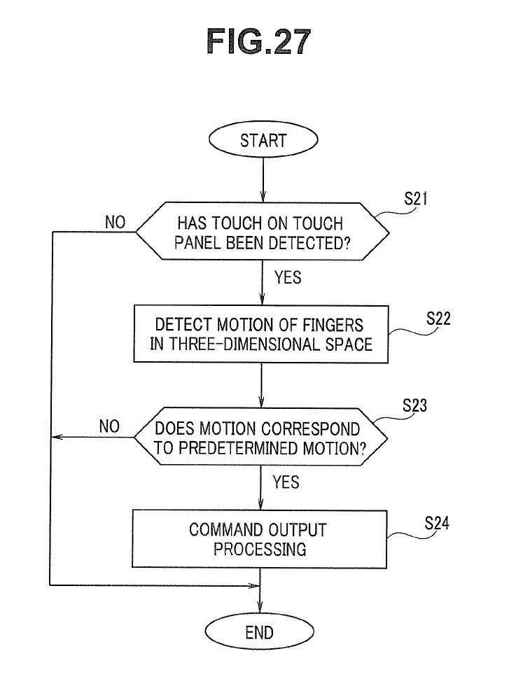

FIG. 27 is a flowchart showing an example of a flow of a command judging process by a touch panel function and a three-dimensional space position detecting function according to the present embodiment. A command judging process program in FIG. 27 is stored in the storage section 15 or the ROM. When various kinds of applications are being executed by the CPU of the control section 11, the command judging process program is read out and executed by the CPU of the control section 11.

By monitoring a touch position signal outputted from the touch panel 13, the control section 11 judges whether a touch on the touch panel 13 has been detected or not (S21). If the touch on the touch panel 13 is not detected (S21: NO), the process does not do anything at all.

When the touch on the touch panel 13 is detected (S21: YES), the control section 11 calculates a track of a motion of a hand or a finger which has left the touch panel 13 within the motion judgment space FDA within a predetermined time period (S22). The processing of S22 constitutes a position detecting section configured to detect a position of a material body in the three-dimensional space opposite to the display surface of the display device 3.

Detection of the motion of the hand or the finger at S22 can be determined from the above-stated equations (1) to (3). That is, by performing detection of a position of the hand or the finger within the motion judgment space FDA within a predetermined time period, for example, within one second, a predetermined number of times, a track of a motion of the hand or the finger is calculated.

Note that, because detection of a motion of a hand or a finger is performed by reflected lights, a hand including fingers is grasped as one material body, and a track of a position of the material body is calculated.

Next, it is judged whether the calculated track corresponds to a predetermined track or not (S23). For example, the predetermined track can be a track of the motion of the left hand LH indicated by the arrow A11 in the case of FIG. 23, a track of the motion of a finger of the left hand LH indicated by the arrow A12 in the case of FIG. 24, a track of the motion of a finger of the left hand LH indicated by the arrow A13 in the case of FIG. 25, and a track of the motion of the finger F3 of the right hand RH indicated by the arrow A14 in the case of FIG. 26.

At S23, it is judged whether or not the calculated track corresponds to the predetermined track within predetermined tolerable limits. If the calculated track corresponds to the predetermined track, the control section 11 generates and outputs a predetermined command (S24). The outputted command is the scroll command in the case of FIGS. 23 and 26, the color-shade changing command in the case of FIG. 24, and a figure rotating command in the case of FIG. 25. When the calculated track does not correspond to the predetermined track (S23: NO), the process does not anything at all.

Therefore, the processing of S23 and S24 constitutes a command generating section configured to generate a predetermined command for causing predetermined processing to be executed on the basis of touch position information about a touch position on the touch panel 13 by a touch operation on the touch panel 13 and position-in-space information about a material body in the three-dimensional space detected by the position detecting section of S22 in a state of the touch panel 13 being touched.

The position-in-space information is information indicating a track of movement of a material body toward a predetermined direction in the three-dimensional space. The predetermined processing is processing for scrolling an image displayed on the display device 3 along a predetermined direction, processing for changing shade of color of an image displayed on the display device 3 on the basis of the position-in-space information or processing for rotating a figure displayed on the display device 3 along a predetermined direction.

As a result, in the present embodiment, it is possible to generate a predetermined command for executing predetermined processing on the basis of position information of a material body within the motion judgment space FDA in a state of the touch panel being touched.

Accordingly, the user can specify the commands for scrolling, rotation and the like of an object such as an image by natural and intuitive finger motions of two hands or two fingers on the tablet terminal 1.

As described above, according to an information processing terminal of the present embodiment stated above, it is possible to provide an information terminal apparatus capable of specifying a command, the commands for scrolling, rotation and the like here, by an intuitive operation without necessity of complicated processing.

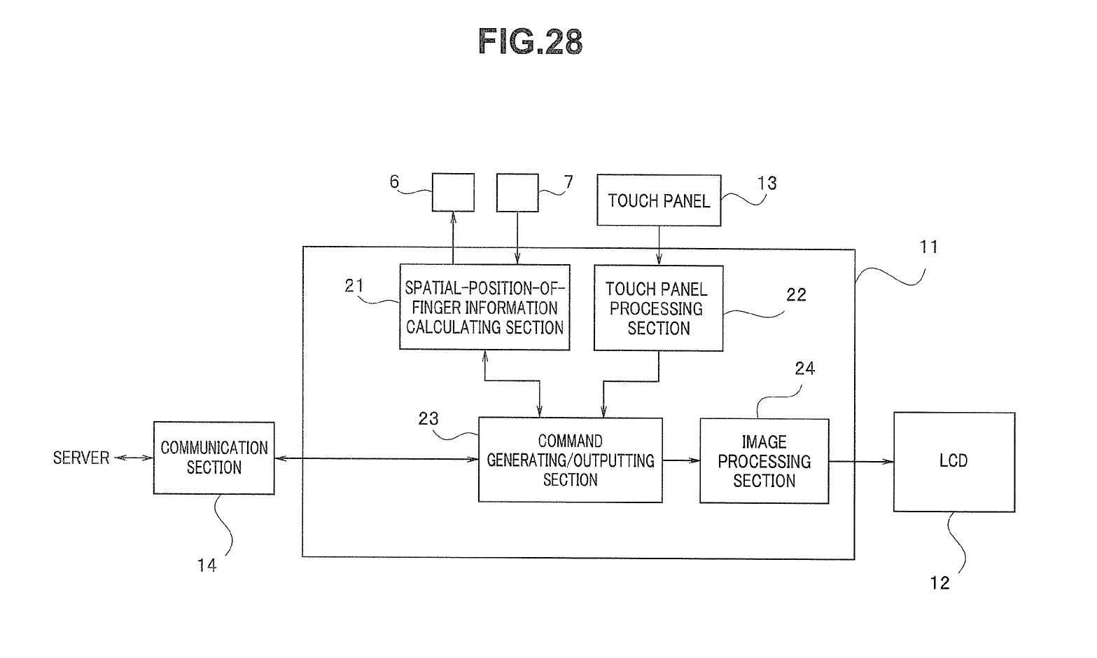

FIG. 28 is a block diagram showing a configuration of a control section including a command generating section of the first to third embodiments. The control section 11 related to the command generating section includes a spatial-position-of-finger information calculating section 21, a touch panel processing section 22, a command generating/outputting section 23 and an image processing section 24.

The spatial-position-of-finger information calculating section 21 is a processing section configured to calculate a position of a finger on a three-dimensional space using the above-stated equations (1), (2) and (3) on the basis of information about an amount of light received by the light receiving section 7 at each light emission timing of the light emitting sections 6, and the spatial-position-of-finger information calculating section 21 corresponds to a processing section of S4 in FIG. 14, S12 in FIG. 22 and S22 in FIG. 27. Therefore, the spatial-position-of-finger information calculating section 21 constitutes a position detecting section configured to detect a position of a material body in the three-dimensional space opposite to the display surface of the display device 3.

The touch panel processing section 22 is a processing section configured to detect an output signal from the touch panel 13 and detect information about a position touched on the touch panel 13, and the touch panel processing section 22 corresponds to processing of S1 and S2 in FIGS. 14 and 22 and processing of S21 in FIG. 27. Therefore, the processing of S2 and the touch panel processing section 22 constitute a touch panel touch detecting section configured to detect that the touch panel 13 of the display device 3 has been touched.

The command generating/outputting section 23 is a processing section configured to output a predetermined command when a state satisfying a predetermined condition is detected, and the command generating/outputting section 23 corresponds to the processing of S5 and S6 in FIG. 14, S13 to S16 in FIG. 22, and S23 and S24 in FIG. 27. Therefore, the command generating/outputting section 23 constitutes a command generating section configured to generate a predetermined command for causing predetermined processing to be executed, on the basis of touch position information about a touch position on the touch panel 13 by a touch operation on the touch panel 13 and position-in-space information about a material body in a predetermined space detected by the position detecting section after the touch panel 13 is touched or in a state of the touch panel 13 being touched.

The image processing section 24 is a processing section configured to perform image processing for zooming, scrolling, rotation, color-shade changing and the like on the basis of a generated command.

Note that, though a position of a finger in a three-dimensional space is detected with the use of multiple light emitting sections and one light receiving section in the examples stated above, a position of a finger in a three-dimensional space may be acquired by image processing using two camera devices, in the case of a relatively large apparatus such as a digital signage.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. An information terminal apparatus comprising:
a display device equipped with a touch panel;
a position detecting section configured to detect a position of a material body in a three-dimensional space opposite to a display surface of the display device; and
a command generating section configured to generate a predetermined command for causing predetermined processing to be executed, on a basis of touch position information of a touch position on the touch panel by a touch operation on the touch panel and position-in-space information of the material body in the three-dimensional space detected by the position detecting section after the touch panel is touched or in a state of the touch panel being touched.

2. The information terminal apparatus according to claim 1, wherein
the touch position information is position information about two points moving near to each other;
the position-in-space information is information indicating a track of movement of the material body from positions of the two points moving near to each other; and
the predetermined processing is processing for moving an image displayed on the display device as if the image were turned.

3. The information terminal apparatus according to claim 1, wherein
the touch position information is position information of two points moving near to each other or moving away from each other;
the position-in-space information is information of the position of the material body in the three-dimensional space in a direction intersecting the display surface of the display device at right angles; and
the predetermined processing is zoom processing for zooming an image displayed on the display device with an amount of zoom determined on the basis of the position-in-space information.

4. The information terminal apparatus according to claim 3, wherein, when the position of the material body in the three-dimensional space is beyond a predetermined position, the amount of zoom is fixed to a first value.

5. The information terminal apparatus according to claim 3, wherein, when a predetermined touch operation is performed against the touch panel, execution of the zoom processing is ended.

6. The information terminal apparatus according to claim 1, wherein
the position-in-space information is information indicating a track of movement of the material body toward a predetermined direction in the three-dimensional space; and
the predetermined processing is processing for scrolling an image displayed on the display device along the predetermined direction.

7. The information terminal apparatus according to claim 1, wherein
the position-in-space information is information indicating a track of movement of the material body toward a predetermined direction in the three-dimensional space; and
the predetermined processing is processing for changing shade of an image displayed on the display device on the basis of the position-in-space information.

8. The information terminal apparatus according to claim 1, wherein
the position-in-space information is information indicating a track of movement of the material body toward a predetermined direction in the three-dimensional space; and
the predetermined processing is processing for rotating a figure displayed on the display device along the predetermined direction.

9. The information terminal apparatus according to claim 1, comprising:
first, second and third light emitting sections arranged around the display surface of the display device; and
a light receiving section arranged around the display surface; wherein
the position detecting section detects a first position on a two-dimensional plane parallel to the display surface and a second position in a direction intersecting the display surface at a right angle based on first, second and third amounts of light obtained by detecting respective reflected lights of lights emitted from the first, second and third light emitting sections, from the material body, by the light receiving section.

10. The information terminal apparatus according to claim 9, wherein the position detecting section determines the first position from a position in a first direction on the two-dimensional plane calculated with values of a difference between and a sum of the first and second amounts of light and a position in a second direction different from the first direction on the two-dimensional plane calculated with values of a difference between and a sum of the second and third amounts of light.

11. The information terminal apparatus according to claim 9, wherein the position detecting section determines the second position in the direction intersecting the display surface at a right angle with a value of a sum of at least two amounts of light among the first, second and third amounts of light.

12. The information terminal apparatus according to claim 9, wherein the first, second and third light emitting sections emit lights at mutually different timings, and the light receiving section detects the reflected lights of the lights emitted from the respective first, second and third light emitting sections according to the different timings.

13. The information terminal apparatus according to claim 9, wherein the first, second and third light emitting sections emit lights with a wavelength outside a wavelength range of visible light.

14. The information terminal apparatus according to claim 13, wherein the light with a wavelength outside the wavelength range of visible light is a near-infrared light.

15. An information terminal apparatus comprising:
a display device equipped with a touch panel;
first, second and third light emitting sections arranged around a display surface of the display device;
a light receiving section arranged around the display surface;
a touch panel touch detecting section configured to detect that the touch panel of the display device is touched;
a position detecting section configured to detect a position of a material body in a space which includes a predetermined three-dimensional space set in advance separated from a display surface of the display device, on the basis of first, second and third amounts of light obtained by detecting respective reflected lights of lights emitted from the first, second and third light emitting sections, from the material body, by the light receiving section; and
a command generating section configured to generate a predetermined command for causing predetermined processing to be executed, on a basis of touch position information of a touch position on the touch panel by a touch operation on the touch panel and position-in-space information of the material body in the three-dimensional space detected by the position detecting section after the touch panel is touched or in a state of the touch panel being touched.

16. The information terminal apparatus according to claim 15, wherein
the touch position information is position information of two points moving near to each other;
the position-in-space information is information indicating a track of movement of the material body from positions of the two points moving near to each other; and
the predetermined processing is processing for moving an image displayed on the display device as if the image were turned.

17. The information terminal apparatus according to claim 15, wherein
the touch position information is position information of two points moving near to each other or moving away from each other;
the position-in-space information is information of the position of the material body in the three-dimensional space in a direction intersecting the display surface of the display device at right angles; and
the predetermined processing is zoom processing for zooming an image displayed on the display device with an amount of zoom determined on the basis of the position-in-space information.

18. The information terminal apparatus according to claim 15, wherein
the position-in-space information is information indicating a track of movement of the material body toward a predetermined direction in the three-dimensional space; and
the predetermined processing is processing for scrolling an image displayed on the display device along the predetermined direction.

19. The information terminal apparatus according to claim 15, wherein
the position-in-space information is information indicating a track of movement of the material body toward a predetermined direction in the three-dimensional space; and
the predetermined processing is processing for changing shade of an image displayed on the display device on the basis of the position-in-space information.

20. The information terminal apparatus according to claim 15, wherein
the position-in-space information is information indicating a track of movement of the material body toward a predetermined direction in the three-dimensional space; and
the predetermined processing is processing for rotating a figure displayed on the display device along the predetermined direction.
